(19) United States
(12) Patent Application Publication
(10) Pub. No.: US 2021/0279760 A1
(43) Pub. Date: Sep. 9, 2021

(54) LOYALTY REWARD SYSTEM AND METHOD

(71) Applicant: Zvi Bogomilsky, Farmingdale, NJ (US)

(72) Inventor: Zvi Bogomilsky, Farmingdale, NJ (US)

(21) Appl. No.: 17/206,091

(22) Filed: Mar. 18, 2021

Related U.S. Application Data
(63) Continuation-in-part of application No. 14/908,988, filed on Jan. 29, 2016, now abandoned.
(60) Provisional application No. 61/861,513, filed on Aug. 2, 2013.

(51) Int. Cl. G06Q 30/02

(52) U.S. Cl. CPC G06Q 30/0226

(57) ABSTRACT

A consumer loyalty reward system where a single member refers additional members to the program. As members conduct transactions (purchases) at participating vendors, the vendors transmit details of the transactions to a processing center. The vendors also transfer to the processing center funds equal to a percentage of the value of the transactions. The processing center compares the value of the members' transactions with vendors in the program, and determines a reward value. Preferably, the reward value attributable to a given member is the lesser of (a) a pre-determined percentage of the value of the member's transactions with a given vendor, and (b) the average value of the transactions of members referred to the program by the given member. The processing center pays the given member the reward value. The system can utilize different percentages for reward values and can also include limitations on the number of referred members.

This application is a continuation-in-part of U.S. patent application Ser. No. 14/908,988, filed Jan. 29, 2016, which claims priority from U.S. Provisional Patent Application No. 61/861,513, filed Aug. 2, 2013.

### FIELD OF INVENTION

The invention is in the field of consumer loyalty programs, specifically programs which reward consumers for purchasing or conducting transactions at identified vendors.

### BACKGROUND

Prior art consumer loyalty programs are based on the customer's own transactions at a particular merchant. The customer shops at the merchant's establishment and as an incentive to being a loyal customer, the merchant rewards the customer with a small cash back bonus—usually up to 2%. The merchant generally cannot reward the customer with a higher cash back bonus, because it cuts into its profit margin. A 25% cash back bonus is practically impossible for the merchant to give because that is usually more than his total profit. It is self-understood that 100% percent cash back is impossible for the merchant to give to all of its customers, because not only will there be no profit for the merchant, it will obviously bankrupt the merchant by giving away its products for free.

The goal of the present loyalty program, is to enable a customer to receive back substantially more than the common 1 to 2 percent cash back amount—anywhere from 1 to 100 percent cash back, and potentially even more than 100 percent cash back—while not costing the merchant or service provider more than a small percentage, for example only 10 percent of the total transaction.

### SUMMARY OF THE INVENTION

The invention is a consumer loyalty program, where an individual single member, referred herein as a prime member, will refer other individuals into the loyalty program, as referred members. Each member, prime or referred, conducts transactions at merchants and vendors in the loyalty program, such as purchases of goods or services. The merchants and vendors provide information about each transaction to a processing center, where the transaction information comprises identification information for the member, identification information for the merchant or vendor, and the dollar amount of the transaction. Optional transaction information may include a percentage reward rate, or other details about the transaction itself, such as the type or quantity of the goods or services purchased. The merchant or vendor will also transmit to the processing center funds reflecting a percentage of the transaction value. The processing center compares the value of the prime member's transactions with those of the referred members, using the transaction values to establish a reward value for the prime member, and the prime member will receive the reward value. The reward value may be a percentage of the value of the prime member's transactions. The transaction comparison may consider all transactions over a period of time, or all transactions with a particular merchant or vendor.

An embodiment of the invention is a method of a consumer loyalty reward program, the method comprising assigning one of a plurality of loyalty cards to at least one prime member; creating an account for the at least one prime member; maintaining a relational database of a plurality of member records on a memory unit; for at least one member, one of the at least one prime member, maintaining a relation with at least one other member, referenced as a referred member, where the prime member and referred member are each a member; in the relational database of member records, maintaining a relation between each of the at least one prime member and at least one organization entity; receiving from a merchant at least one transaction detail record, the transaction detail record comprising information of a transaction between the merchant and a member; assigning each referred member to one of a plurality of loyalty cards; creating an account for each referred member; curating a list of qualified purchases based on the at least one transaction detail record; calculating, via a processor, an average monthly qualified spending for each member; assigning at least one prime member as a leader of at least one of a plurality of groups, each group having a number of members; calculating a rebate; and rewarding the rebate to the leader.

In a further embodiment of the invention, each group has a capacity of twenty members. In another embodiment, the method may further comprise calculating an average monthly qualified spending of each referred member; and assigning each referred member to one of the plurality of groups by comparing the average monthly qualified spending of each referred member to the average monthly qualified spending of each prime member. In another embodiment, the method may further comprise calculating an individual average qualified spending. In an embodiment, the rebate may be calculated by R=(y)(c)(iAMS) where c is a constant. In an embodiment, the method may further comprise recalling a transaction price, a funds value, and a credit value; determining whether the leader's funds value is sufficient; determining whether the leader's credit value is sufficient; determining whether the rebate is sufficient; approving the transaction if the leader's funds value, credit value, or rebate, is greater than or equal to the transaction price; and denying the transaction if the leader's funds value, credit value, or rebate, is not greater than or equal to the transaction price. In one embodiment, each referred member becomes a new prime member after a pre-determined period of time. In a further embodiment, each new prime member is assigned as a leader of one of the plurality of groups. In on embodiment, each member may contribute funds to a future spending account, where the contributions to the future spending account are included in the calculation of a qualified monthly spending.

### BRIEF DESCRIPTION OF THE DRAWINGS

FIG. 1 is a diagram showing the relationship between a prime member and referred members according to the invention.

FIG. 2 is a diagram showing the relationship between a prime member and referred members with a second level of referred members according to a variation of the invention.

FIG. 3 is a flow diagram showing the relationships between members, a single merchant and the loyalty processing center of the invention.

FIG. 4 is a flow diagram showing the relationships between members, multiple merchants and the loyalty processing center of the invention.

FIG. 5 is a diagram showing an example of a database.

FIG. 6 is a flow diagram showing an algorithm for rebuilding statistics.

FIGS. 7-10 are flow diagrams showing examples of retrieving a range of variables from an account.

FIG. 11 is a flow diagram showing validation of a purchase.

FIG. 12 is a flow diagram showing insertion of a new user account.

FIG. 13 is a flow diagram showing an embodiment of a main program.

FIG. 14 is an example of a computer code configured to run on the system and to execute one or more algorithms.

### DETAILED DESCRIPTION OF THE PREFERRED EMBODIMENT

The present invention adds a whole new dimension of basing a consumer's cash back benefit on the average of the transactions done by the members referred by the consumer to the program. There are two types of members; the referring or prime member 100 and the referred members 200. The prime member 100 recruits other members to the program who then become his referred members 200.

The invention also provides for merchants or vendors 300 (hereinafter “merchants”) to participate in the loyalty program. As individual members (100, 200) conduct transactions with the merchants 300, the merchant 300 records details of the transaction including a member's unique identification code and the date and value of the transaction. As an optional feature, the merchant may also include the full details of the transaction, such as method of payment, number of products or services purchased. The merchant would transmit the transaction details 350 to a processing center 400. The transmission may occur daily, weekly, monthly, or without a particular frequency.

The processing center 400 maintains a relational database of members (100, 200) and merchants 300. For a given prime member 100, the database includes links to the members 200 who were referred to the loyalty program by the prime member. The preferred embodiment of the loyalty program includes a limit on the number of referred members associated with a prime member. The database also includes information regarding an account associated with the prime member for the purpose of transferring funds.

The processing center 400 receives transaction details 350 from merchants 300 and associates the transactions with the respective members (100, 200). The processing center 400 may calculate the total or aggregate value of transactions conducted by a member (100, 200), aggregating the transaction values by merchant, time period, product or service purchased, or any combination of these factors. The processing center 400 establishes an aggregate value for the prime member 100, and also establishes an aggregate value for the referred members 200 associated with the prime member.

The loyalty program is preferably set up to encourage all members to patronize the same merchants. The preferred comparison would be for the processing center 400 to compare the aggregate value of transactions by the prime member 100 at all merchants 300 with the average aggregate value of transactions by the referred members 200 at the same merchants 300. If the average aggregate value of referred member transactions equals or exceeds the aggregate value of prime member transactions, the processing center would preferably calculate a reward value equal to a percentage of the aggregate value of the prime member transaction. If the average aggregate value of referred member transactions is less than the aggregate value of prime member transactions, the processing center would calculate a reward value equal to a percentage of the average aggregate value of referred member transactions.

An alternate embodiment would base the calculations upon transactions at a set of merchants 300 or a single merchant 300. Another variation of the present invention would calculate a reward value for the prime member based solely upon the value of the referred member transactions, without taking into account any transactions by the prime member.

Along with the transaction details 350, the processing center 400 receives funds 370 from a merchant 300. These funds may be transferred from merchant 300 to processing center 400 by any means known in the art. The amount of the funds 370 transferred from merchant 300 to processing center 400 is preferably a percentage of the value of the transactions conducted by members (100, 200), but may also be a fixed or pre-determined amount.

The funds 370 received by the processing center 400 are preferably divided among the processing center 400, members (100, 200) and optionally, organizations 500. Where organizations 500 are involved in the loyalty program, these organizations can use the loyalty program as a means of fundraising.

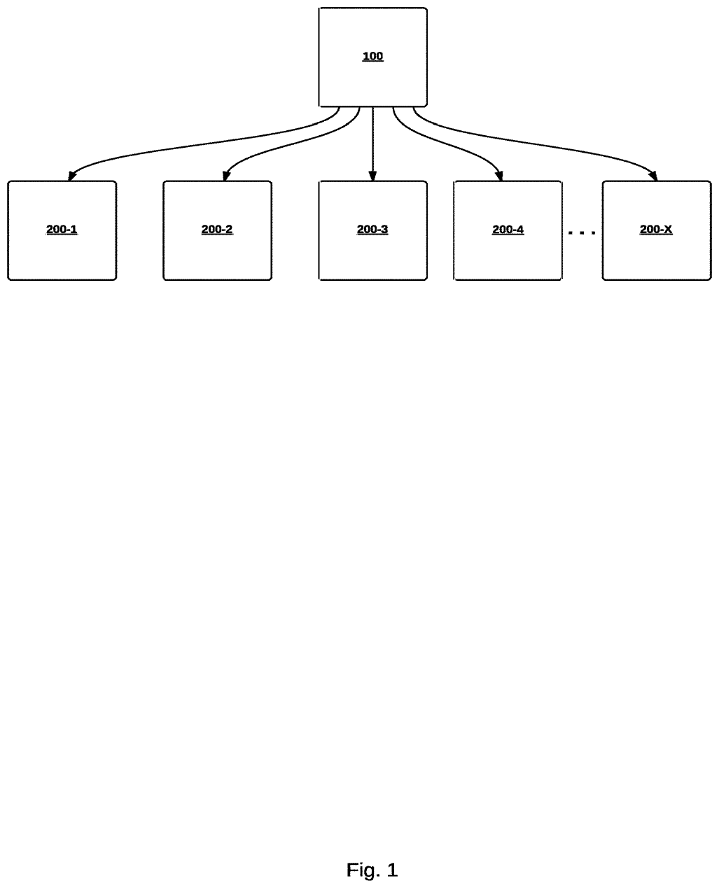

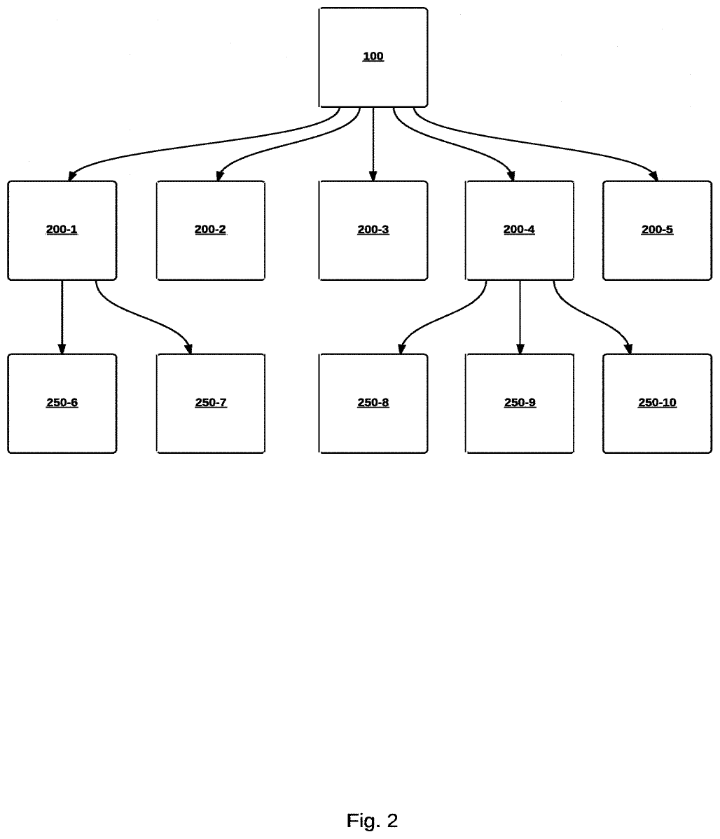

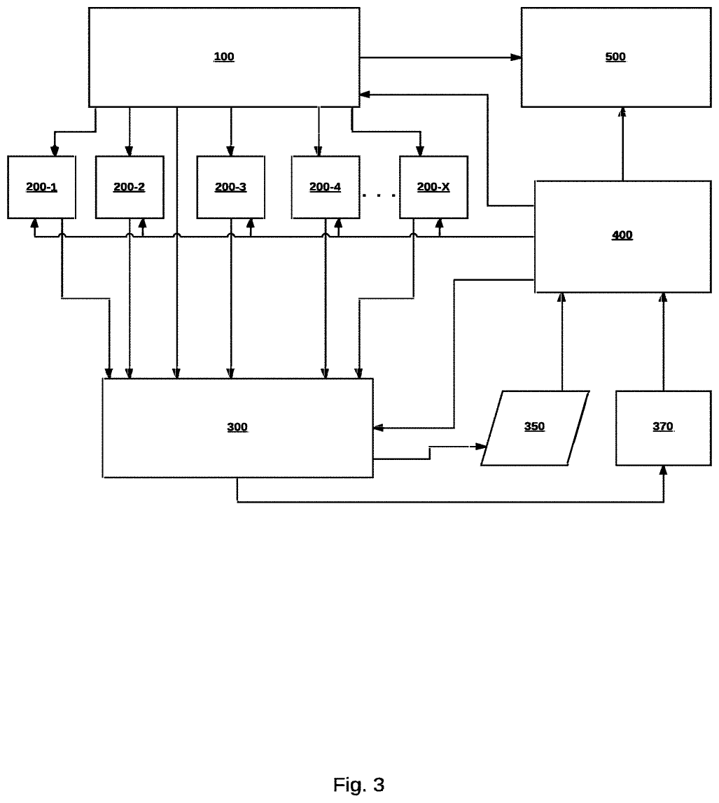

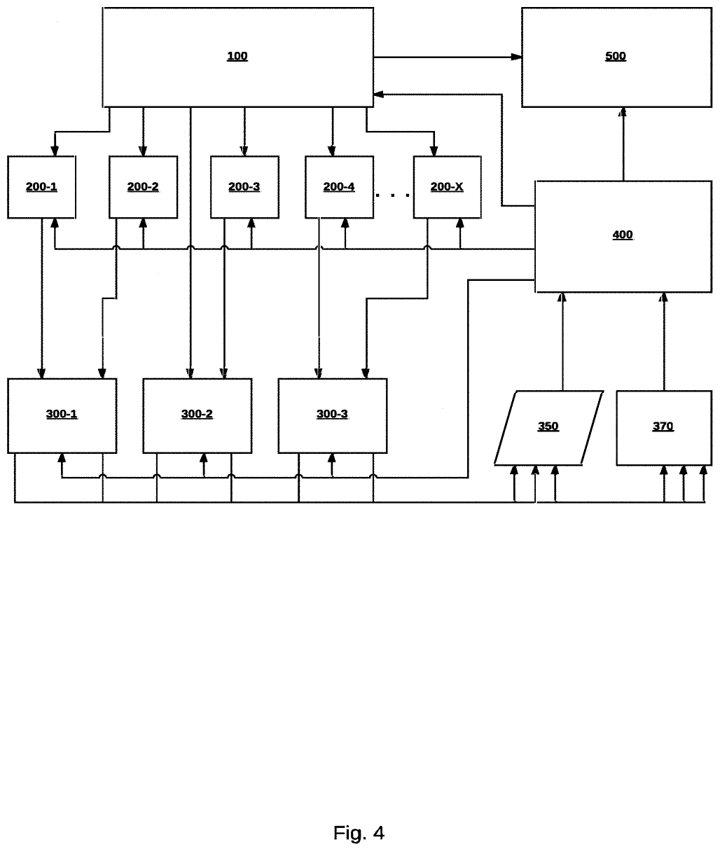

There are two principal ways to implement the loyalty program of the present invention. The first method uses a wide one-level group system, as shown in FIG. 1. Any member that is recruited by the prime member is ranked directly under the prime member and is only connected to the prime member.

The present invention is unlike the well-known multi-level or pyramid type system, which provides multiple levels and are dependent on many transactions in the levels beneath a given member, incentivizing the member to recruit more customers, who in turn must also recruit more members, etc. In contrast, in the present invention, the prime member is only connected to the referred members, who are placed under the prime member in a wide (but not deep) group. Preferably the program would be implemented with a maximum group size, with a maximum number of referred members being between 10 and 20.

An alternate embodiment of the present invention, as shown in FIG. 2, would provide for a multi-level system where the prime member can also benefit from the transactions done by members 250 who were referred by each referred member 200 related to the prime member.

The desired end result of returning to the prime member 100 up to 100% or even more then 100% of their transactions can be accomplished in a number of ways. The factors such as how many referred members or the percentage returned may be adjusted to get the desired percentage returned to the prime member 100.

Also, each referred member 200 would be encouraged to go and refer their own members 250 to the program, thereby enabling the referred members to also get up to 100% or possibly even more than 100% of their transactions returned to them.

The loyalty program creates an alliance between the merchants, schools and non-profit organizations, and their members. By encouraging the members of their organizations to shop at participating merchants, the organization 500 can benefit from the merchant's donation to the organization, preferably a percentage of the transactions done by its members. This creates good will in the community, and members are happy to patronize merchants that support their causes. Organizations 500 can be separate from members (100, 200, 250), or can also be treated as members (100, 200, 250) in the loyalty program.

The following example is for illustration purposes only and can be done with many other percentage amounts and different number of referred members. This example uses the layout shown in FIG. 1, a wide one-level grouping of referred members 200.

The loyalty program encompasses many different merchants and service providers, with each participating merchant or service provider, offering a small cash back benefit through the loyalty program to all the members of the loyalty program. The loyalty program facilitates the relationship between the merchants and customers. Through its unique loyalty program that will be explained in detail, the customer effectively receives anywhere from 1 to 100 percent cash back and possibly even more than 100 percent cash back.

Optionally, all members (100, 200) may initially receive a 2% cash-back benefit on their purchases made at participating merchants 300. Once 5 people are referred to the program by the member, the prime member 100 will get 25% of the average of the purchases made by the member's referred members 200 in a cash back benefit. Once the prime member 100 refers 5 additional members for a total of 10 referred members 200, the benefit to the prime member 100 will increase to 50%, another 5 additional referred members 200 for a total of 15 members, will increase the benefit to 75%, and with 5 additional members for a total of 20 referred members, the benefit will reach 100%.

An optional feature would allow the prime member 100 to receive more than 100%, such as referring 5 additional members for a total of 25 referred members 200, will generate 125% cash back, and 5 more additional members for a total of 30 members, will increase the benefit to 150% cash back. The value of the benefits to the members can be adjusted through a combination of adjusting the percentage of each transaction which can be used to credit the member, as well as the number of referred members for each prime member.

The cash back benefit can be adjusted based on how much the prime member 100 personally spends at participating merchants and service providers. For example: If the member only spent $500 in the month of January, and 20 referred members 200 spent an average of $1,000, the member would only get back $500. A reason to design the payout in that manner would be to encourage the prime member 100 to spend as much as possible at participating merchants and service providers.

There are many ways to structure the program, from being completely dependent on the member's own spending, partially dependent on the member's spending, to being independent from the member's spending in a given month, year, or other time frame. The program may also factor in the member's spending on a single merchant, a collection of merchants, or all merchants in the loyalty program.

In a preferred embodiment, the loyalty program system would have each merchant 300 that joins the loyalty program, agree to give a 10% cash back benefit to the loyalty program, on every transaction done by a member (100, 200, 250) in the loyalty program. For example: If ten members (100, 200-1, 200-2, 200-3, etc.) shopped at merchant 300-1 in the month of January, and each transaction was for $100, then at the end of January merchant 300-1 would give the loyalty program a total of $100—10×$10—which equals 10% percent of the ten transactions done by the loyalty members.

Varying the preceding example, if the ten members also shopped for the same amounts at merchant 300-2, 300-3, 300-4, etc., each additional merchant would then also give the loyalty program $100 at the end of January for the transactions done at their establishments by members.

For the purpose of understanding how the system works, assume that all the ten members 200 were referred by the same prime member 100. The loyalty program will then reward $500 to the prime member 100—which is 50% of the average of all transaction done by the referred members 200. If 20 of the referred members 200 each did the same amount in transactions ($100) at each of the ten merchants, then each merchant 300 would give $200 (20×$10) at the end of the month to loyalty program, and the prime member 100 will receive 100% of the average of all transactions done by the referred members 200 in the month of January, which in this case would be $1,000.

In a preferred embodiment of the invention, where the prime member does not conduct transactions, either over a period of time or with a particular merchant, the prime member would not be entitled to any cash back reward. The system therefore encourages participation by all members.

An optional feature of the loyalty program would add a rating system for the members. In the preferred embodiment, each prime member 100 will not have access to the transaction details for the related referred members 200. However, as the transactions of referred members 200 may directly affect the cash back paid to prime member 100, prime member 100 will want to have some information about the activities of referred members 200. In the embodiments of the invention where the prime member 100 is limited to a particular number of referred members 200, the prime member 100 may want to disassociate from one referred member 200 that is not engaging in transactions through the loyalty program and add a new referred member 200 as a replacement.

In order to increase the average potential cash back to the prime member 100, each referred member 200 will be rated based on the value of transactions conducted. As an example, the rating system may be a star rating of 1 to 5 stars. If each star represents $500 worth of transactions in a given calendar month, and the referred member 200 spends $1,000 he will get a 2 star rating. This way the prime member 100 will be able to see which of his or her referred members 200 are spending at or above the prime member's own average, and thereby increasing the cash back benefit, and which referred members 200 are spending below the prime member's average and thereby decreasing the cash back benefit. The prime member 100 will have the option of removing those referred members 200 from his or her network that may be decreasing the cash back benefit to the prime member, and replace them with members that are more aligned with the prime member's transaction rate and volume.

The funds received by loyalty program from the merchants 300 could be used to (a) pay the initial 2% benefit that each member may get as an initial incentive to join the loyalty program, (b) pay the prime member 100 and referred members 200 their cash back benefits, (c) an administrative fee for the loyalty program, and (d) donate or support additional organizations, such as charities and not for profit entities.

There are various methods of tracking the daily transactions done by members of the loyalty program, at the various participating merchants and service providers. The basic method would be through issuing a loyalty program card to every member that joins the program. This card can have either a magnetic strip or smart chip similar to a credit card that stores the loyalty program member's information, or a barcode similar to a rewards card, all as is known in the art. The card would be swiped or scanned at the point of sale of the participating merchant, and thereby provide the member's information for the transaction detail sent from the merchant to the processing center 400. Another way would be through the use of a smart phone that has a loyalty program application that would either transmit the member's information to the merchant's POS system or other similar device, or generate a barcode that can be scanned at the POS system. This information can either be stored locally on the participating merchant's computer, and synchronized periodically with the loyalty program's processing center, or would transmitted instantly to the loyalty program's processing center.

Another method of identifying the loyalty program member at the merchant's establishment would be through the use of biometrics, such as a fingerprint scanner or iris scanner, or other biometric device. The advantage of using the biometric method for identifying a member would be that the member would not have to have his loyalty card with him in order to benefit from the transaction.

Another method would be for the loyalty program member to provide his or her account number or other identification, such as telephone number, to the merchant at the time of the transaction.

Preferably, each member would have access to his or her own personal account on the loyalty program's website, and see their own transaction details and the average of referred members' transactions. The member would also be able to see all the cash back benefits earned in a given time frame. There would also be the option of having a daily text message or email sent to the member with daily transaction updates.

The merchants and service providers that are participating in the loyalty program may also have their own access on the loyalty program website, enabling them to see all the transactions that were done at their establishment by members of the loyalty program. The merchants will also be able to keep track of the payments that were made to the loyalty program.

The member can pay for a transaction in well-known usual methods, namely, cash, check, debit card, credit card, etc. or may use a loyalty program card or smart phone application as a form of payment. There are various methods of doing the latter: (a) having the member load cash from his bank account onto the loyalty program card or smart phone application; (b) having the card or smart phone application act as credit card; (c) having the member transfer the cash back benefit to his loyalty program card or smart phone application; or (d) using a biometric method, the member would be able to pay for the transaction with the simple swipe of his finger or iris scan, and the funds would either be deducted from his account, or paid with the default method of payment on file (e.g. credit card or debit card).

With the unique benefits that the loyalty program offers, any store can change their approach in conducting their business to something so unique, it is unlike anything existing on the market today. For starters the business model of the store would be that there is a standard price for each product (usually competitive with the general market). However, the store would not have to lose money on having their products go on sale to attract customers. Each customer that comes into the store that is a member of the loyalty program, will in essence have their own private “sale” based on their current standing in the loyalty program. For example: If the merchant is selling a product for $100, under the current system, if it wants to attract customers to buy that product it might need to discount the product's price by 10-50% and incur a major loss in potential profits. With the loyalty program the merchant could sell the same product to multiple customers and would not have to incur more than a small discount (for example a 10% discount) that is paid to the loyalty program, while the member-customers will receive cash back, through the loyalty program, anywhere from 1% to 100% or perhaps higher.

As the network of participating merchants and service providers grow, it is anticipated that almost every daily expense, such as rent or mortgage payments, utilities, insurance, medical, transportation, property maintenance, child support, education, food, restaurants, travel, entertainment, etc. would be able to be purchased as a loyalty program member, and the members will receive the benefits associated with the loyalty program from all daily expenditures.

Being that a member is likely to get back a majority, if not all of their daily expenses, and possibly even more than they spent, their disposable income will increase exponentially. The merchants and service providers participating in the loyalty program will see a major increase in the quantity and quality of purchases made by members and it would well be worthwhile the relatively small transaction fee that they are paying the loyalty program.

Another implementation of the invention would replace conventional payment methods for goods and services outside of a retail environment. For example, instead of buying expensive health insurance to cover basic medical care, a member may be able to use the loyalty program to pay for a participating doctor and the member would be “reimbursed” through the loyalty program. The doctor will be able to be compensated fairly for his or her services without being undercut by the insurance company, and the quality in healthcare will increase while giving greater choice to the patient.

As another example, with the loyalty program, a quality education would be available to everyone regardless of their current financial condition. Members would not have to worry how to put their children through college, or being forced to send their children to public school. As long as the school or college is participating in the loyalty program, most or all of the money spent on education can come be repaid to the member.

Taxes are another area where the loyalty program can be implemented. Even though taxes are mandated by government and the taxpayer does not have the option of not paying his taxes, nevertheless, using the loyalty program would greatly benefit both the taxpayer and government. There is a very delicate balance between higher taxes to increase revenue, and at the same time not placing too heavy a burden on the taxpayer and stunting the economy from growing. The loyalty program may allow the government to raise the tax rate and increase revenue, while the taxpayer will effectively pay less in taxes by getting part or all of the tax payment paid back, thereby stimulating the economy exponentially.

In an embodiment, the system may include one or more algorithms to develop a loyalty credit card system with a non-pyramidal account structure. In an alternate embodiment, the system may include one or more algorithms to develop a loyalty credit card system with a pyramidal account structure. In one embodiment, the algorithms are configured to target a PC or Linux server. However, in another embodiment, the algorithms may be configured to run on any operating system. In an embodiment, the one or more algorithms may be configured in Python, MySQL, or MarinaDB, or AWS and Elastic Beanstalk and Docker. AWS Elastic Beanstalk is a service for deploying and scaling web applications and services developed with Python and Docker on servers such as Apache, Nginx, etc. One may upload the code and Elastic Beanstalk may automatically handle the deployment (for example, from capacity provisioning, load balancing, auto-scaling to application health monitoring). At the same time, one may retain full control over the AWS resources powering the application and access to the underlying resources.

In an embodiment, one algorithm may assign a loyalty card to an existing member, create an account for the existing member and track the existing member's qualified spending (“QS,” for example, purchases made from designated “in-network” vendors) using the loyalty card. In one embodiment, such an algorithm may then calculate an existing member's average monthly qualified spending (“AMS”) over a given time period.

In an embodiment, an algrorithm may assign a loyalty card for each newly registered member. In a further embodiment, an algorithm may then create an account for each member and track newly registered members' QS values using their loyalty cards.

In an embodiment, an algorithm may assign the existing member as a “Leader” of a group with a cap of y members (for example, y≤20).

In an embodiment, an algorithm may assign up to y newly registered members to the group by matching the AMS of the newly registered members (“nxAMS”) to the AMS of the Leader (“nLAMS”) according to the following inequality:

Permin*nLAMS<nxAMS<Permax*nLAMS

Permin=0.9

Permax=1.10

In another embodiment, the inequality may be adjusted for a multitude of Permin and Permax values.

In an embodiment, for any given month, the algorithm may calculate an individual AMS (“iAMS”) for the group as a whole for that month:

$$i A M S = \frac{\sum n x M S}{y} \\ nxMS = qualified spending of a member for the month$$

$$x = 1 to y$$

In an embodiment, the algorithm may calculate and award rebate (“R”) to the Leader each month, provided R does not exceed the Leader's MS for that month:

R=y(0.04)(iAMS), R<nLMS

In alternate embodiments, the constant, 0.04, may be replaced by any value.

In an embodiment, the algorithm may determine whether to approve a purchase by the Leader for a transaction with purchase price (“P”) by: (1) determining if the Leader has sufficient funds (“F”) in his account (“A”); (2) determining if the Leader has sufficient credit (“C”) for his account A; (3) determining if the pending rebate R is sufficient; and (4) if F, C, or R equals or exceeds P, then approve the transaction; if not, then reject.

In an embodiment, each newly registered member becomes an existing member after a given time period, and are assigned as Leaders of their own groups. In an embodiment, the algorithm may allow members to contribute funds into a Future Spending Account, (“FSA”) each month. In an embodiment, contributions to an FSA may be included in their nxMS calculation.

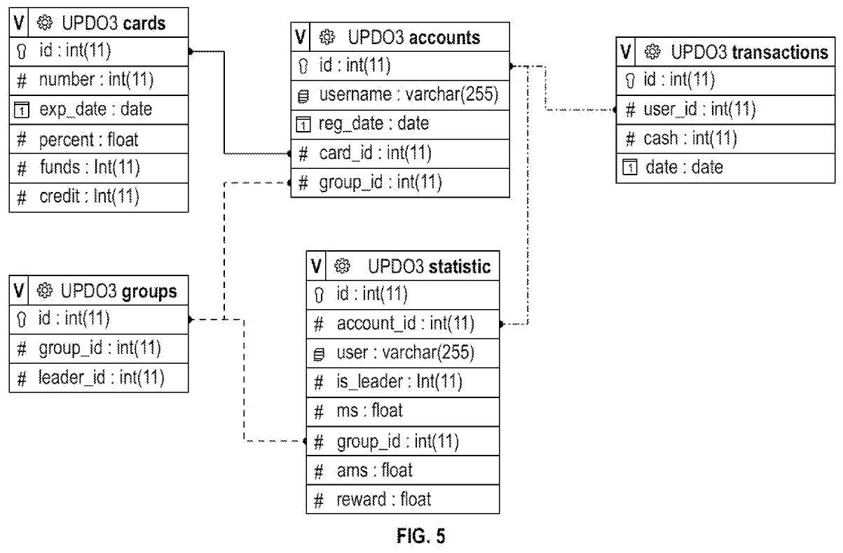

Referring to FIG. 5, the system may include a database divided into one or more tables. As a non-limiting example, the one or more tables may include: cards (store loyalty credit card data, FSA), accounts (users' information, registration date, card ID), groups (relations between users and groups), transactions (tracks all user transaction), and statistics (the main table that stores all information as a result of running the one or more algorithms, including, but not limited to: groups, leaders, MS, AMS, and reward algorithms).

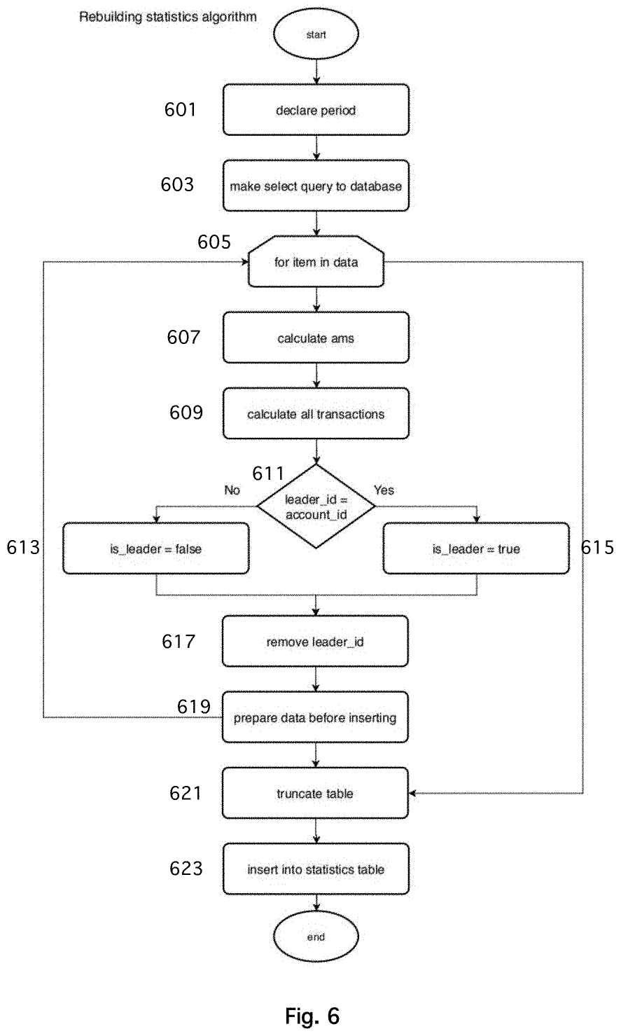

FIG. 6 illustrates an algorithm configured to rebuild the statistics. In such an embodiment, after starting, the algorithm may declare a period 601, followed by making a select query to a database 603. The algorithm may next search for the item in the database 605. The algorithm may then calculate the AMS 607 and calculate all transactions 609. If the leader_id is equivalent to the account_id 611, then is_leader may return as true 615. If the leader_id does not equate to the account_id 611, then is_leader may return as false 613. The algorithm may then remove the leader_id 617 and prepare the data before inserting 619. Once again, the algorithm may then search for the item in the database 605. Finally, the algorithm may then truncate a table 621 and insert into statistics table 623.

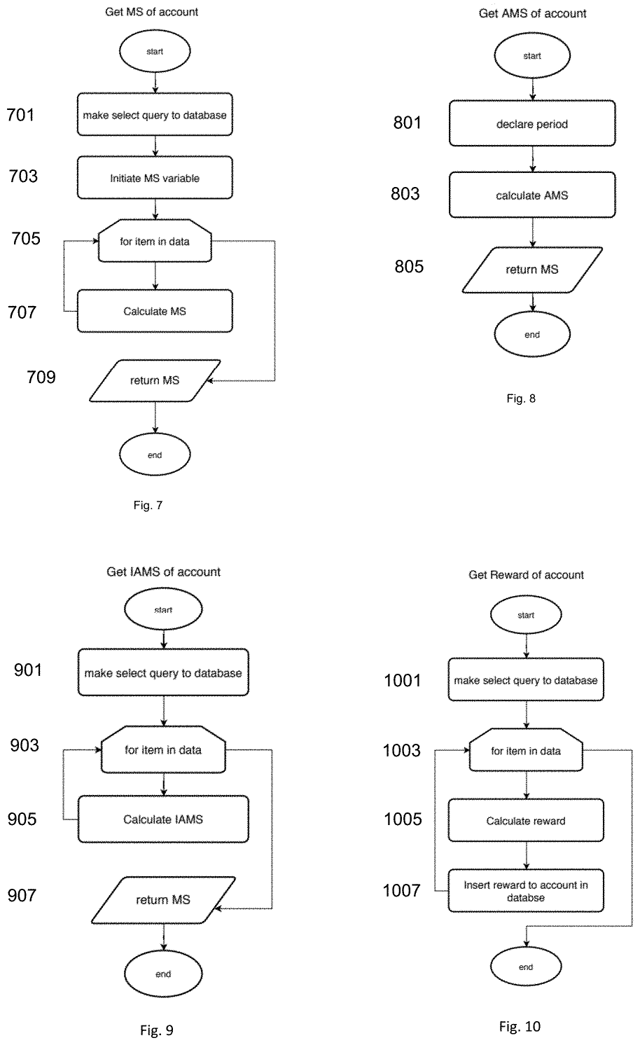

FIG. 7 illustrates an algorithm configured to get the MS of an account. In such an embodiment, after starting, the algorithm may select a query to a database 701 and then initiate the MS variable 703 for an item in the database 705. The algorithm may then calculate the MS 707, check for the item in the database 705, and return the MS 709.

FIG. 8 illustrates an algorithm configured to get the AMS of an account. In such an embodiment, after starting, the algorithm may declare a period 801, calculate the AMS 803, and return the MS 805.

FIG. 9 illustrates an algorithm configured to get the IAMS of an account. In such an embodiment, after starting, the algorithm may select a query to a database 901 for an item in the database 903. The algorithm may then calculate the IAMS 905 for an item in the database 903, and return the MS 907.

FIG. 10 illustrates an algorithm configured to get the reward for an account. In such an embodiment, after starting, the algorithm may select a query to a database 1001 for an item in the database 1003. The algorithm may then calculate the reward 1005 and insert the reward to the account in the database 1007 for an item in the database 1003.

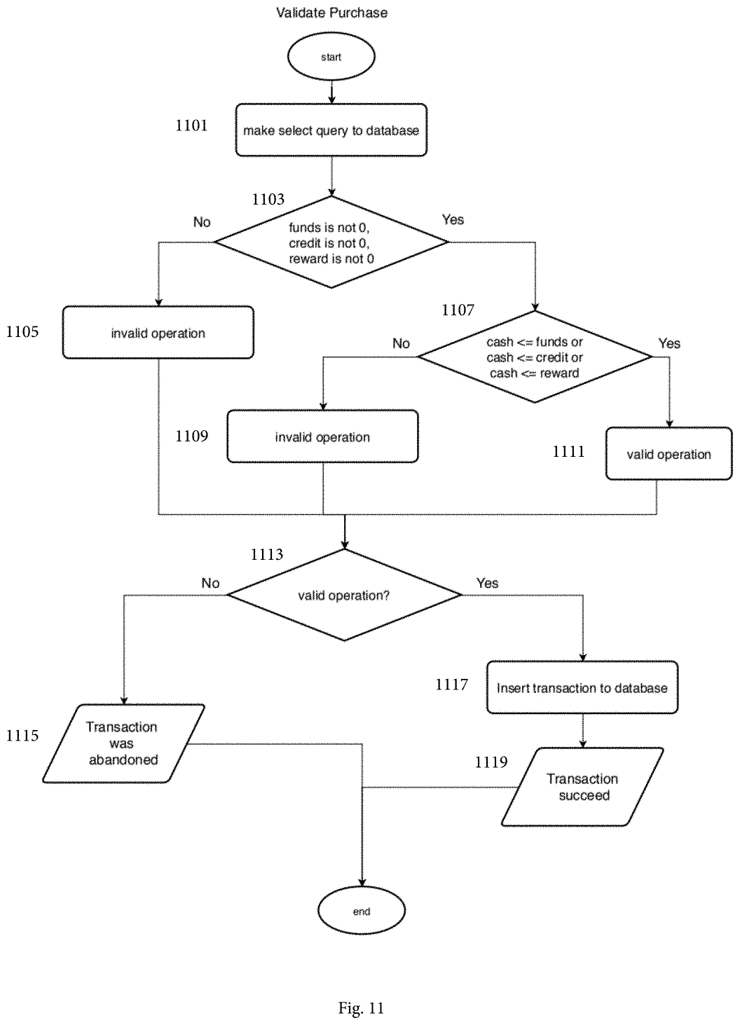

FIG. 11 illustrates an algorithm configured to validate a purchase. In such an embodiment, after starting, the algorithm may select a query for a database 1101 and determine whether funds, credit, and reward are zero 1103. If the funds, credit, and reward are non-zero, then the algorithm determines whether cash is less than funds, credit, or reward 1107. If step 1107 is true, the algorithm determines that the operation is valid 1111. If step 1101 is false, the algorithm determines that the operation is invalid 1109. If the funds, credit, and reward are zero, then the algorithm determines that the operation is invalid 1105. In an embodiment, the algorithm assesses whether an operation is valid 1113. If the operation is valid 1113, the algorithm may insert the transaction into the database 1117, enabling the transaction to succeed 1119. If the operation is invalid 1113, the transaction may be abandoned 1115.

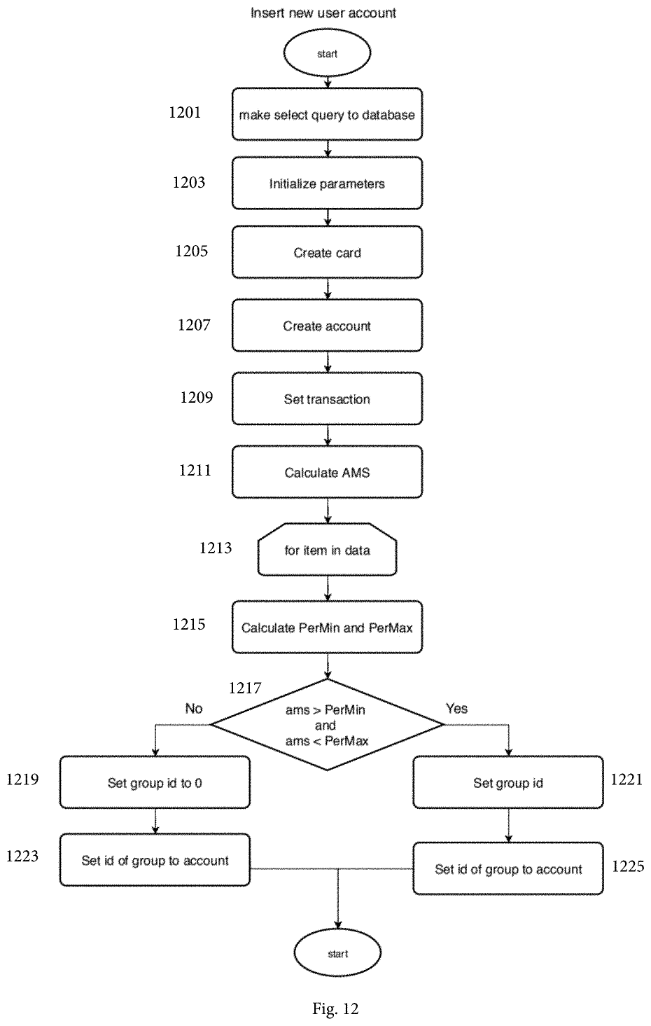

FIG. 12 illustrates an algorithm configured to insert a new user account. In an embodiment, after starting, the algorithm may select a query to a database 1201, initialize parameters 1203, create a card 1205, create the account 1207, set the transaction 1209, calculate the AMS 1221, and calculate the PerMin and PerMax 1215. The algorithm may then determine whether the AMS is greater than the PerMin and less than the PerMax 1217. If no, the algorithm may set the group id to zero 1219 and set the id of group to the account 1223. If yes, the algorithm may set the group id and set the id of group to the account 1225.

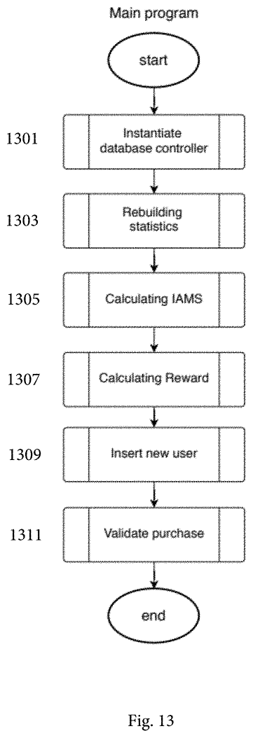

FIG. 13 illustrates a main program algorithm configured to incorporate one or more algorithms. In an embodiment, after starting, the algorithm may instantiate a database controller 1301, rebuild statistics 1303, calculate the IAMS 1305, calculate the reward 1307, insert the new user 1309, and validate the purchase 1311.

In an embodiment, the system may include one or more servers or client devices. In an embodiment, the system may include a processor/CPU, memory, a power supply, and input/output components/devices (for example, microphones, speakers, keypads, etc.). A user may provide input via a touch screen or other interface. The system may also include a communication bus that facilitates electronic communication via aforementioned components.

The processor may include one or more types of processing devices (for example, a central processing unit or a graphics processing unit). The memory may include random access memory and/or read only memory. In an embodiment, the memory can be configured to be a primary storage device or a secondary storage device (for example, flash memory, magnetic disk, optical disk, or other similar components). The memory may include an operating system and data storage, which may include one or more databases, applications, programs, and algorithms.

In an embodiment, any of the aforementioned computing components are capable of sending, receiving, and processing data over a wired and/or wireless network may act as a server. Thus, other computing devices (for example, individual desktop computers or mobile devices) may receive input and output from the system (for example, algorithms stored on the memory and executed by the processor, may receive input from other computing devices and output results to those same other computing devices).

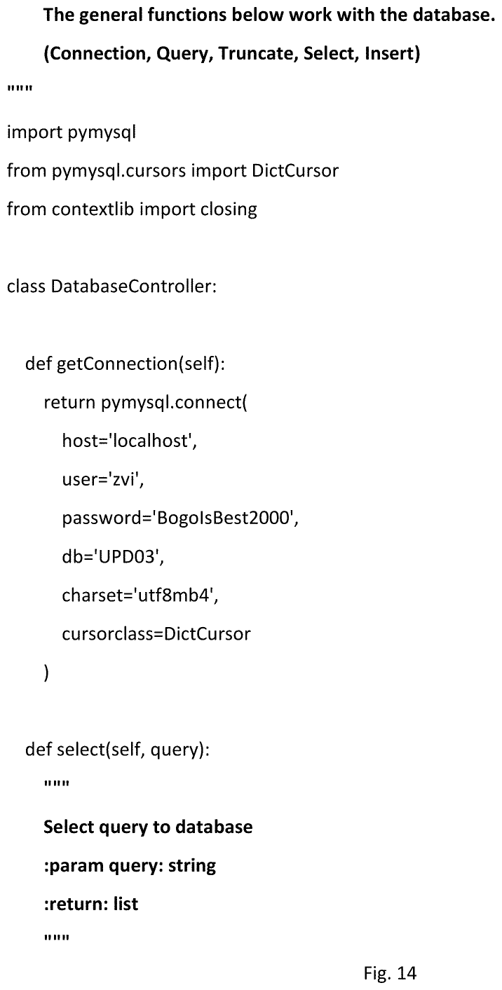

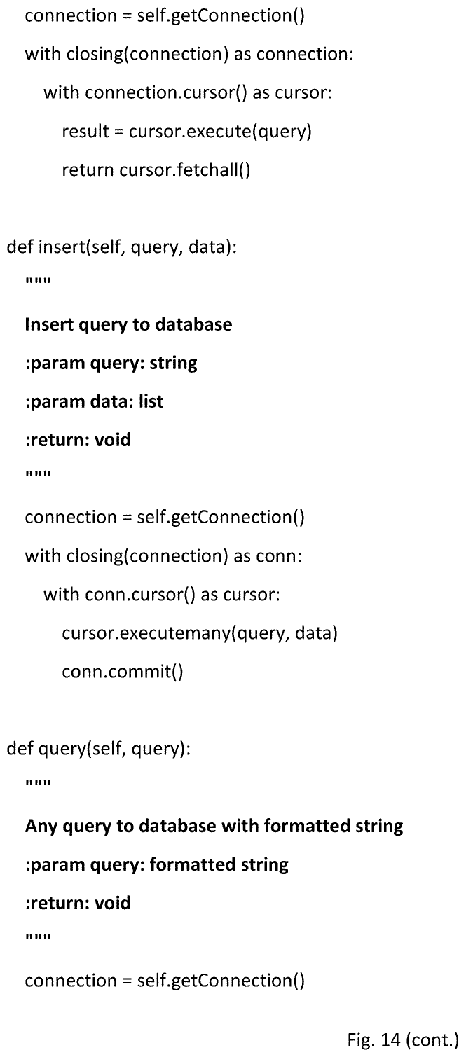

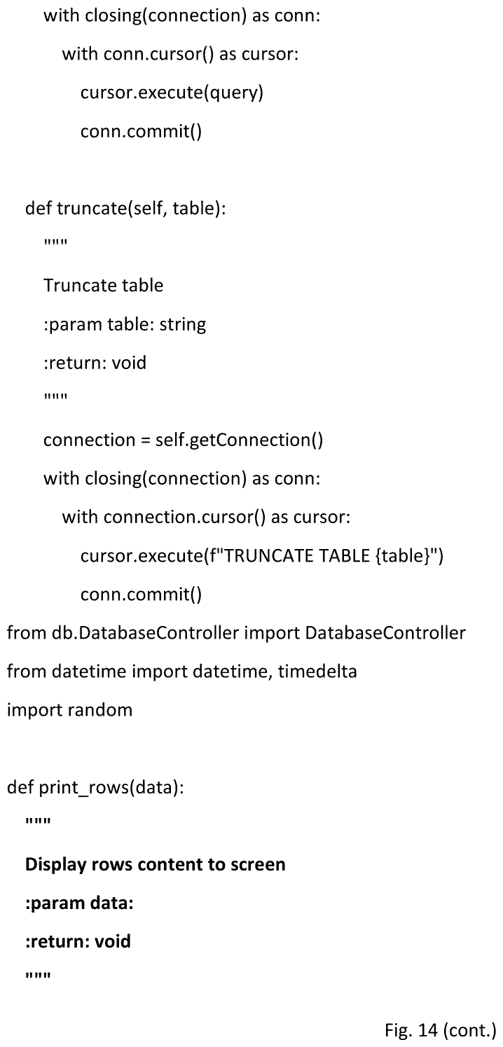

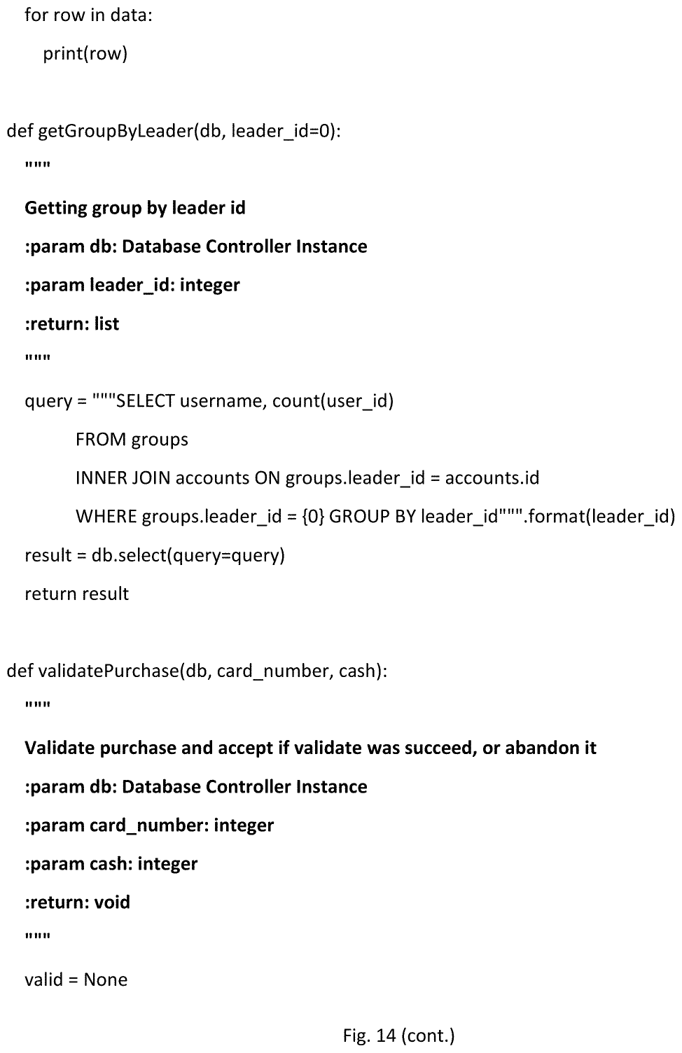

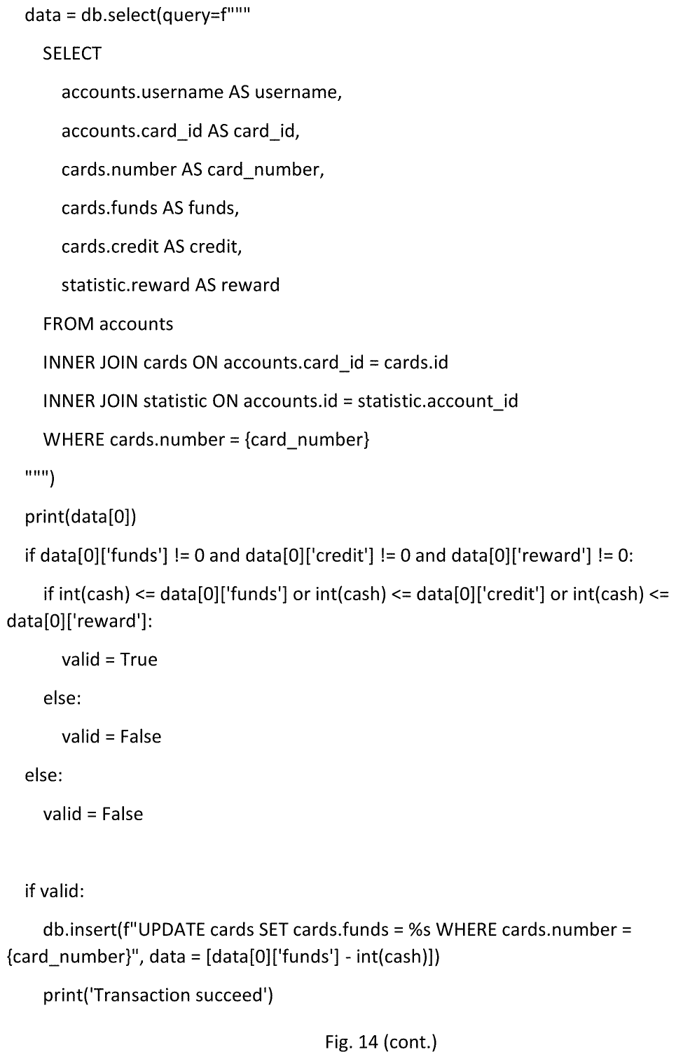

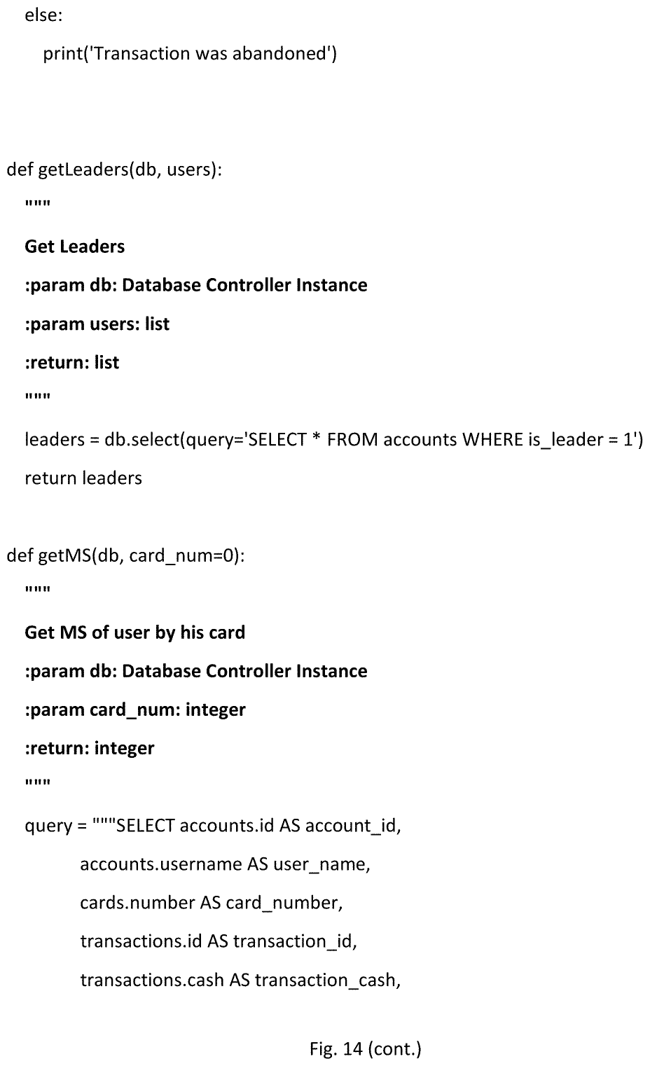

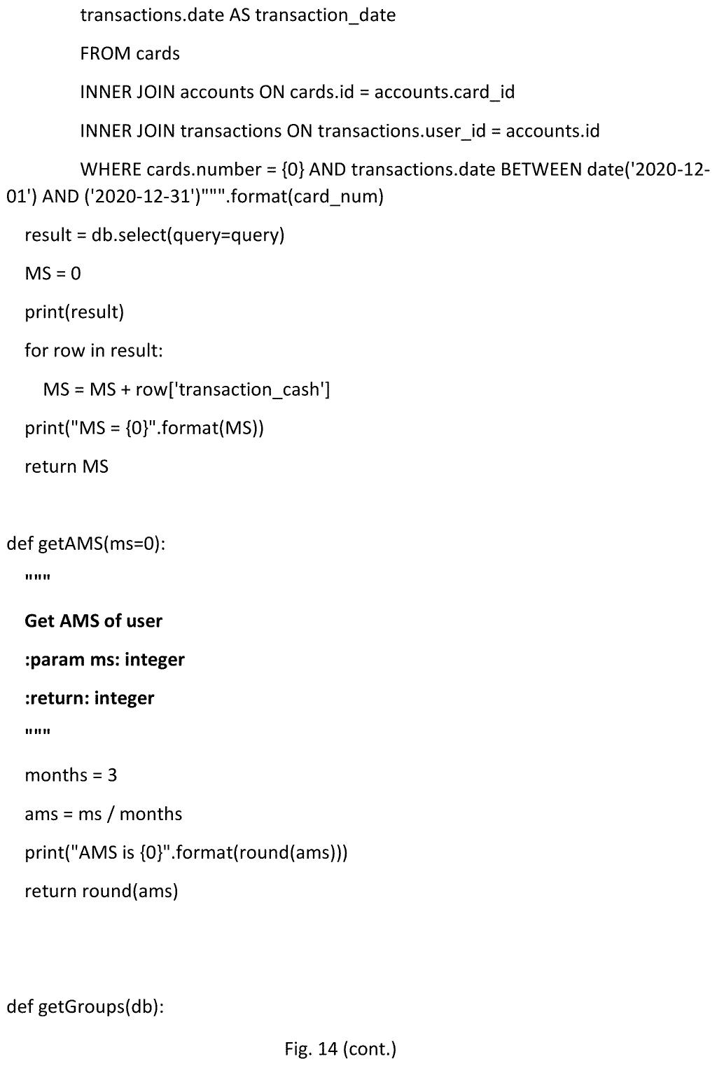

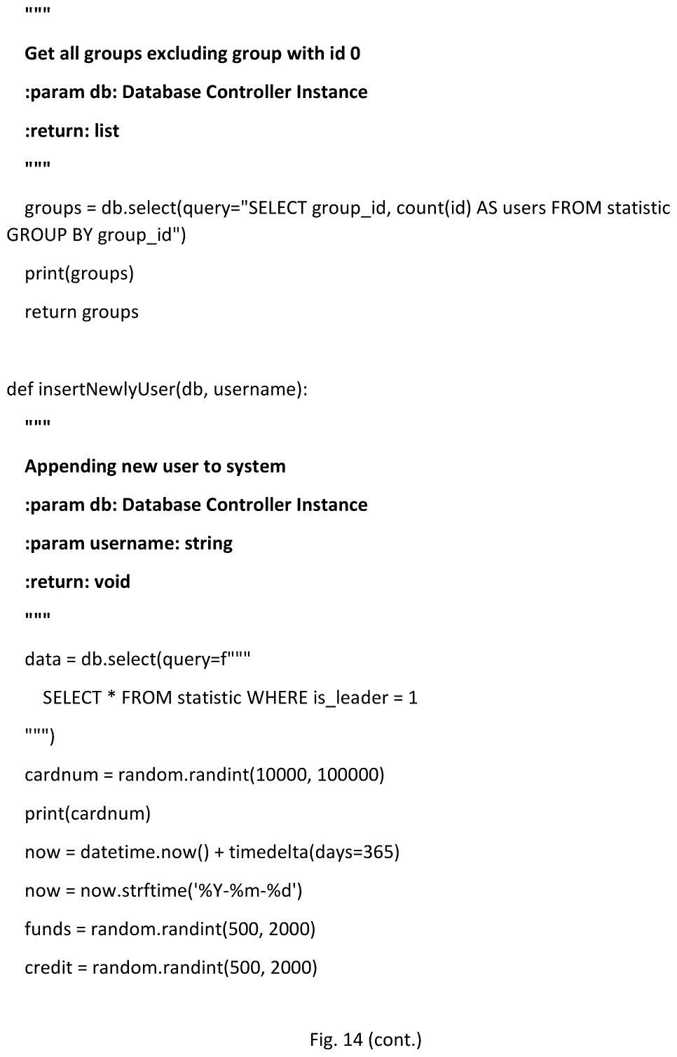

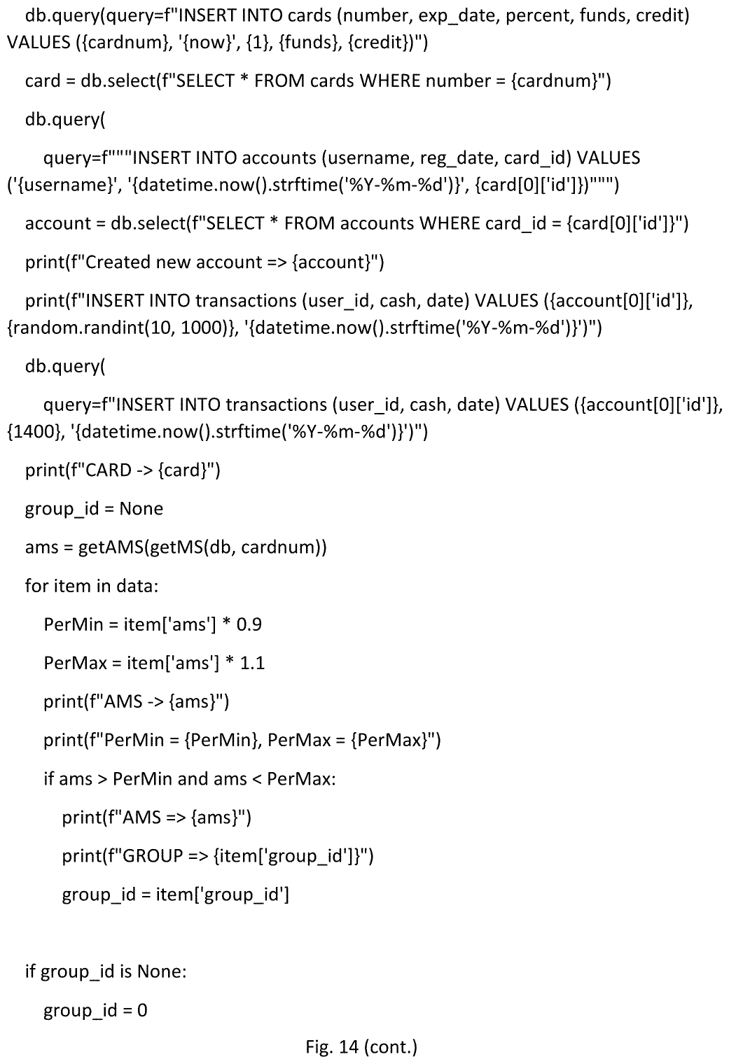

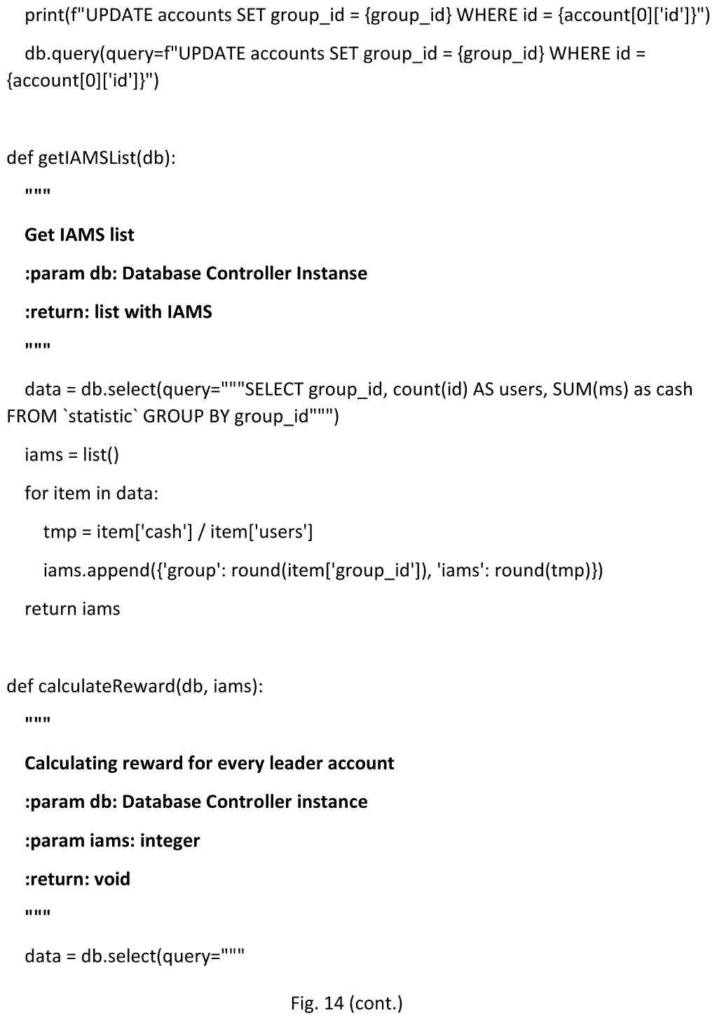

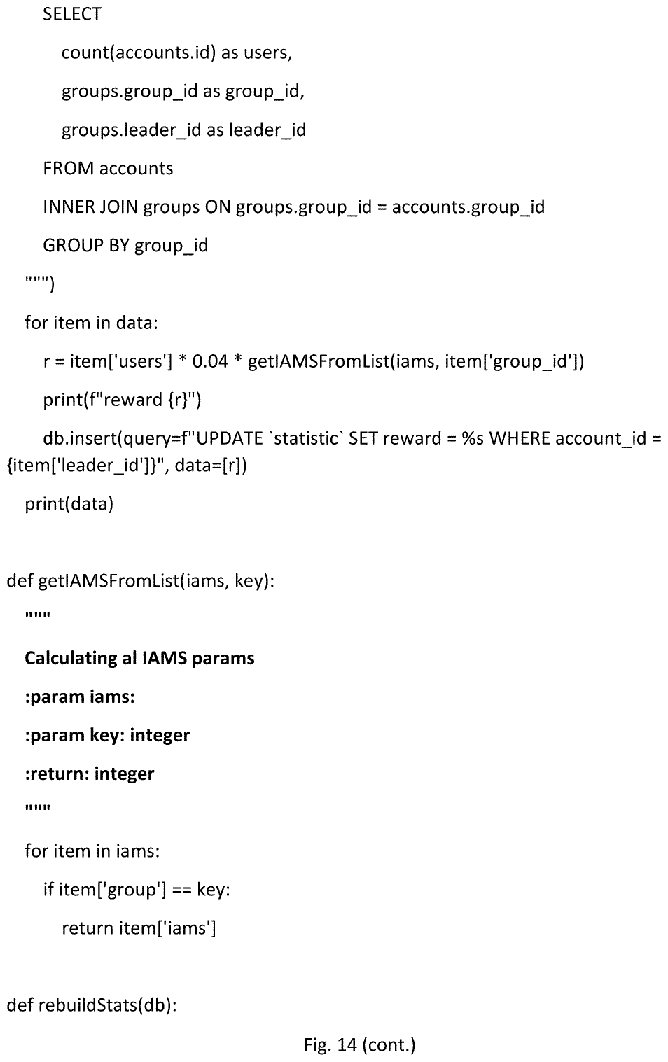

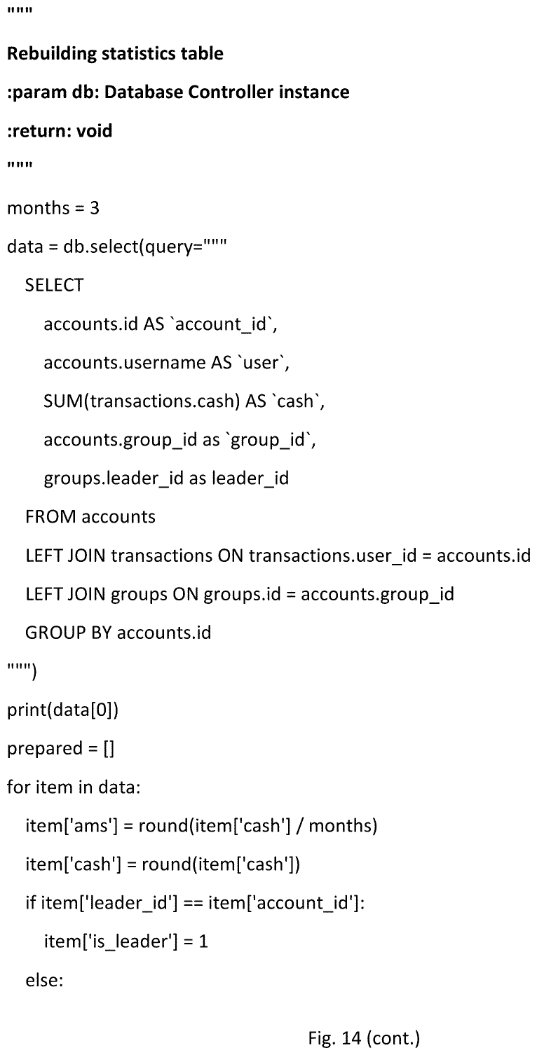

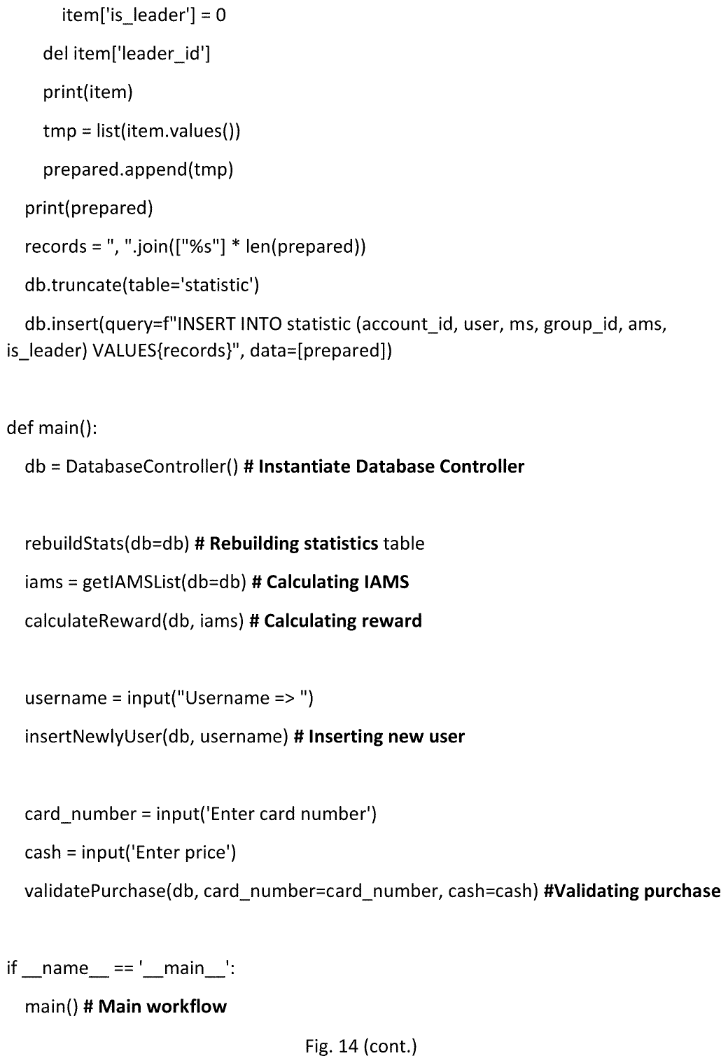

FIG. 14 depicts an example of computer code configured to execute one or more of the aforementioned algorithms. The computer code may be stored on the memory.

In an embodiment, the invention of the present disclosure includes a future spending account (“FSA”). The objective of such a fund may be to help cover major expenses (for example, a Bar Mitzvah or Wedding) that a middle class family may struggle to afford. In an embodiment, the FSA is configured to allow a user to strategically put away money to cover major expenses, while not diminishing daily expenses. In one embodiment, the FSA structure is based on the rule that in order for the leader to get back the rebate generated by his or her group spending, the leader must also spend that amount in the network.

As a non-liming example, in the month of January a group of 25 members spend a total of $125,000, and that generated a rebate of $5,000. Normally, the group leader would also have to spend $5,000 in the month of January at the network of vendors, in order to get back the full $5,000 on February 1st. In such an example, if the group leader can only spend $4,000 in the month of January, then his or her rebate on February 1st will only be $4,000 (he or she will effectively lose $1,000). In such an example, the leader may have two options: (1) on January 31st when he or she sees that there is a $1,000 difference between his or her spending and the rebate generated by the group spending, he or she can quickly go on a $1,000 shopping spree in the network. He or she will then get back the full $5,000 on February 1st; or (2) he or she can put $1,000 in his or her fund account, and that will be considered as if he or she spent it in the network. On February 1st, he or she will receive the full $5,000 in his or her regular account. In such an embodiment, if the leader wants to pay for a $25,000 Wedding roughly 2 years from now, he or she can put $1,000 in the fund account every month over a 25-month period. At the end of 25-months he or she will have $25,000 in the fund account that he or she already got back as an equivalent amount in the regular account. Further, in such an example, because, while the fund continues growing from month to month, on the first of every month the leader may be getting back into the regular account (that one uses for daily/weekly/monthly expenses) every dollar that was put away into the fund account the previous month (for example, up to the rebate generated by his or her group spending in that calendar month).

In one embodiment with the fund account, one can save money for future major expenses, while not diminishing the money you need for your daily expenses. In such an example, when the time comes to have the Wedding, he or she books a wedding hall, and hires a caterer, photographer, musicians, etc. that are in the network, and pays them using the money that is in the fund. In such an embodiment, by putting money every month in his or her fund, he or she is prepaying for a future event, that he or she has the full freedom to decide exactly how he or she wants to make. Further, in such an example, he or she is not locked into a certain vendor or service provider—the only requirement is that it has to be in the network.

In an embodiment using the fund account, a group leader may pay, for example, on June 15th $25,000 for a Wedding, and by June 30th he or she will have spent an additional $5,000 in the network for his or her usual expenses—so in the month of June he or she will have spent a grand total of $30,000, while from the group spending it still only generated a rebate of $5,000—and nevertheless get back the full $30,000. Further, in such an example, he or she will get $5,000 on July 1st as the usual rebate that was generated by the group spending, and the $25,000 that he or she spent on the Wedding from the fund account, he or she already got back in the past 25 months—$1,000 a month that went into the regular account on the first of every month (that was part of the monthly rebate—in part based on the $1,000 a month that he or she was putting in the fund account in every prior month). In an embodiment, the fund account may also be used for any other big-ticket item that is not part of the usual daily/weekly/monthly expenses. Non-limiting examples include: furniture, major appliances, electronics, computers, Jewelry, vacation getaways, and home improvements.

While certain novel features of the present invention have been shown and described, it will be understood that various omissions, substitutions and changes in the forms and details of the device illustrated and in its operation can be made by those skilled in the art without departing from the spirit of the invention.

What is claimed is:

1. A method of a consumer loyalty reward program, the method comprising:
assigning one of a plurality of loyalty cards to at least one prime member;
creating an account for the at least one prime member;
maintaining a relational database of a plurality of member records on a memory unit;
for at least one member, one of the at least one prime member, maintaining a relation with at least one other member, referenced as a referred member, where the prime member and referred member are each a member;
in the relational database of member records, maintaining a relation between each of the at least one prime member and at least one organization entity;
receiving from a merchant at least one transaction detail record, the transaction detail record comprising information of a transaction between the merchant and a member;
assigning each referred member to one of a plurality of loyalty cards;
creating an account for each referred member;
curating a list of qualified purchases based on the at least one transaction detail record;
calculating, via a processor, an average monthly qualified spending for each member;
assigning at least one prime member as a leader of at least one of a plurality of groups, each group having a number of members;
calculating a rebate; and
rewarding the rebate to the leader.

2. The method of claim 1, where each group has a capacity of twenty members.

3. The method of claim 1, further comprising:
calculating an average monthly qualified spending of each referred member; and
assigning each referred member to one of the plurality of groups by comparing the average monthly qualified spending of each referred member to the average monthly qualified spending of each prime member.

4. The method of claim 3, further comprising:
calculating an individual average qualified spending (“iAMS”) by:
iAMS=ΣnxMS/y
where nxMS is the monthly qualified spending of a member and y is the number of members.

5. The method of claim 4, where the rebate is calculated by:
R=(y)(c)(iAMS)
R≤nLMS
where R is the rebate, nLMS is the leader's qualified monthly spending, and c is a constant.

6. The method of claim 1, further comprising:
recalling a transaction price, a funds value, and a credit value;
determining whether the leader's funds value is sufficient;
determining whether the leader's credit value is sufficient;
determining whether the rebate is sufficient;
approving the transaction if the leader's funds value, credit value, or rebate, is greater than or equal to the transaction price; and
denying the transaction if the leader's funds value, credit value, or rebate, is not greater than or equal to the transaction price.

7. The method of claim 1, where each referred member becomes a new prime member after a pre-determined period of time.

8. The method of claim 7, where each new prime member is assigned as a leader of one of the plurality of groups.

9. The method of claim 1, where each member may contribute funds to a future spending account.

10. The method of claim 9, where the contributions to the future spending account are included in the calculation of a qualified monthly spending.
